(19) United States
(12) Patent Application Publication
(10) Pub. No.: US 2016/0097555 A1
(43) Pub. Date: Apr. 7, 2016

(54) SMARTPHONE-OPERATED HVAC ANEMOMETER DEVICE AND SYSTEM

(71) Applicant: Weatherflow, Inc., Scotts Valley, CA (US)

(72) Inventors: Daniel Lyons, Soquel, CA (US); Scott Madden, Hollywood, FL (US); David St. John, New Smyma Beach, FL (US); Derek Trauger, Deland, FL (US)

(21) Appl. No.: 14/818,912

(22) Filed: Aug. 5, 2015

Related U.S. Application Data
(60) Provisional application No. 62/059,327, filed on Oct. 3, 2014.

(51) Int. Cl. F24F 11/00; G01P 5/06

(52) U.S. Cl. CPC F24F 11/001; G01P 5/06; F24F 11/006; F24F 11/008; F24F 2011/0038; F24F 2011/0041; F24F 2011/0061; F24F 2011/0069

(57) ABSTRACT

A smartphone-operated HVAC airflow anemometer device and system includes an anemometer device having an impeller and a photo interrupter circuit. The circuit generates an output signal that is proportional to the rotation speed of the impeller, and transmits the same via a headphone jack to a smartphone device running an airflow balancing application. The airflow balancing application receives airflow data from the anemometer and provides power to the same. The application can apply one or more algorithms to the received airflow data to generate airflow information which can be stored or transmitted by the smartphone device.

### CROSS-REFERENCE TO RELATED APPLICATIONS

This application claims the benefit of U.S. Application Ser. No. 62/059,327 filed on Oct. 3, 2014, the contents of which are incorporated herein by reference.

### TECHNICAL FIELD

The present invention relates generally to airflow measurement devices, and more particularly to an anemometer device which can utilize the processing and communicative abilities of a smartphone to obtain, store and distribute accurate airflow readings.

### BACKGROUND

The statements in this section merely provide background information related to the present disclosure and may not constitute prior art.

Heating, Ventilating, and Air Conditioning (HVAC) systems are designed to create and maintain stable climate controlled environments with clean circulated air. As such, one of the main goals of any HVAC system is to achieve occupant comfort, while ensuring the system operating costs are as low as possible. One of the main factors in reaching this goal is to balance the air ducts for proper warm or cool air delivery, thereby ensuring the entire structure is maintained at a uniform temperature.

Airflow balancing is typically performed by qualified HVAC technicians who use specialized equipment to determine the airflow emanating from each supply duct and/or entering each return duct. Once obtained and recorded, this information can be utilized to adjust the output and/or input of each individual air duct, thereby resulting in an even distribution of air within the overall system.

Some of the key information needed to properly balance an HVAC system includes taking measurements of the air velocity, calculating the air volume, and accounting for the AK factor. In this field, air velocity (distance traveled per unit of time) is usually expressed in linear feet per minute (LFM) or meters per second (m/s). By multiplying air velocity by the cross section area of an air duct, you can determine the air volume flowing past a point in the duct per unit of time. Volume flow is measured in cubic feet per minute (CFM) or cubic meters per hour (M3/h). The AK factor is the amount of free space available for airflow when there is a grille in place. AK factors are typically provided by the manufacturer on the grille itself and can be provided in inches or percentage of obstructed free space.

There are many known commercially available anemometer devices which function to measure airflow. As such, these traditional devices are purpose-built, standalone equipment having dedicated onboard components such as a CPU/processor, memory, display screen, user keyboard and sensor(s), for example. In this regard, traditional anemometers are not multi-functional, and must be carried and utilized in conjunction with other such equipment by a technician.

Accordingly, it would be beneficial to provide a small, inexpensive anemometer device which can utilize the processing and communicative abilities of a smartphone to obtain, calculate, store and transmit airflow information pertaining to an HVAC system.

### SUMMARY OF THE INVENTION

The present invention is directed to a smartphone-operated HVAC anemometer device and system. One embodiment of the present invention can include an anemometer device having an impeller and a photo interrupter circuit. The circuit functions to generate an output signal that is proportional to the speed at which the impeller rotates. A headphone jack having a plurality of terminals can be removably inserted into a smartphone device to send and receive information.

The system also includes an airflow balancing application which can be downloaded onto a smartphone device. The application can generate one or more icons for accessing the application functionality, can instruct the smartphone to provide power for the anemometer device, and can receive airflow data from the anemometer. The application can also function to apply one or more algorithms to the received airflow data to generate airflow information such as air velocity and air volume, for example.

Another embodiment of the present invention can include the ability for the airflow balancing application to store and transmit airflow information to secondary devices utilizing the communicative abilities of the smartphone.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a smartphone-operated HVAC anemometer device and system that is useful for understanding the inventive concepts disclosed herein.

FIG. 2 is an exploded parts view of the smartphone-operated anemometer device of FIG. 1, in accordance with one embodiment of the invention.

FIG. 3 is a simplistic block diagram of the photo interrupter circuit of the anemometer device, in accordance with one embodiment of the invention.

FIG. 4 illustrates one embodiment of an output signal which can be generated by the anemometer device, in accordance with one embodiment of the invention.

FIG. 5 is a flow chart schematic of the airflow balancing application (“App”) of the smartphone-operated anemometer system, in accordance with one embodiment of the invention.

FIG. 6 illustrates an exemplary display screen which can be generated by the airflow balancing application, in accordance with one embodiment of the invention.

FIG. 7 illustrates an exemplary display screen which can be generated by the airflow balancing application, in accordance with one embodiment of the invention.

FIG. 8A illustrates an exemplary display screen which can be generated by the airflow balancing application, in accordance with one embodiment of the invention.

FIG. 8B illustrates an exemplary display screen which can be generated by the airflow balancing application, in accordance with one embodiment of the invention.

FIG. 9A illustrates an exemplary display screen which can be generated by the airflow balancing application, in accordance with one embodiment of the invention.

FIG. 9B illustrates an exemplary display screen which can be generated by the airflow balancing application, in accordance with one embodiment of the invention.

FIG. 10 illustrates an exemplary display screen which can be generated by the airflow balancing application, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

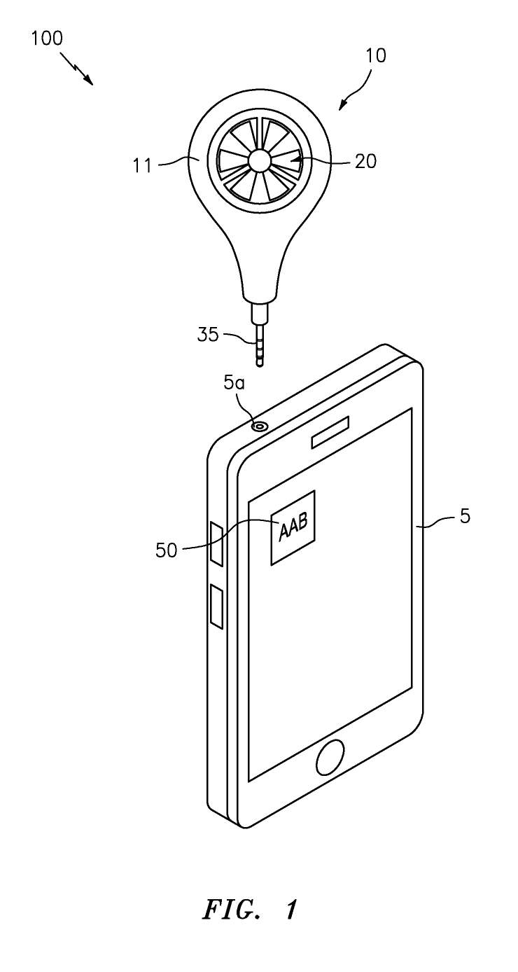

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

A smartphone-operated anemometer system 100 can function to allow a user to quickly and easily capture airflow data from the HVAC system of a building or other desirable location utilizing an anemometer device 10 that is physically coupled with a smartphone or other such device running an airflow balancing application 50. As such, the system 100 can utilize the processing power, storage and communicative abilities of the smartphone to accurately measure and/or calculate airflow information. In this regard, the system can utilize the smartphone to power the anemometer device, to receive data from the device, to apply complex calculations and algorithms to the received data, to provide onscreen user guidance, and to create and send reports containing the received and/or calculated information.

As described throughout this document, the term “airflow data” can include any form of information that can be captured by the below described anemometer device. Likewise, the term “airflow information” can include any data that is received or calculated from the airflow data that is supplied in whole, or in part by the below described anemometer device 10. Several nonlimiting examples of airflow information include: air velocity and air volume, for example.

In the below described examples, programming code for implementing the anemometer system can be presented in the form of a smartphone mobile application (i.e., App) which can be preloaded on a smartphone device, or downloaded and installed as an application after purchase of the smartphone device. Of course, the inventive concepts disclosed herein are not to be construed as limiting to a smartphone App, as virtually any type of instruction sets, in any form of programming language that can be executed on a processor enabled device are also contemplated.

Although described for use with a smartphone, this is for illustrative purposes only, as any type of processor enabled device that is capable of providing two way communication with a secondary device and/or a human operator can be utilized herein. Several nonlimiting examples include portable computers, tablet computers, PDA's, portable music devices (MP3 players) and wearable devices such as smartphone watches, for example. Accordingly, the device and/or method steps are not to be construed as limiting in any manner.

A user's smartphone or tablet device generally includes installed software adapted to generate an airflow balancing icon that is included with the airflow balancing application 50, and to display same on the display screen of the smartphone device. An actuating means is provided for actuating the airflow balancing icon through use of a touch sensitive smartphone or tablet screen, and/or a keypad, for example. Selecting the airflow balancing icon launches the system application and/or launches a linked web page through internet connectivity wherein the below described presentation screens are generated.

FIGS. 1-10 illustrate various embodiments of a smartphone-operated HVAC anemometer system 100 that are useful for understanding the inventive concepts disclosed herein. As shown, in FIG. 1, the system can include an anemometer device 10 which can be removably connected to the headphone jack 5a of a smartphone 5 running the airflow balancing application 50.

In this regard, the anemometer device 10 can include, essentially, a main body 11, an impeller 20, and a photo interrupter circuit 30 with an audio jack plug 35. The main body 11 can preferably be constructed from injection molded plastic, so as to create a single, lightweight portable device that can house each of the device elements.

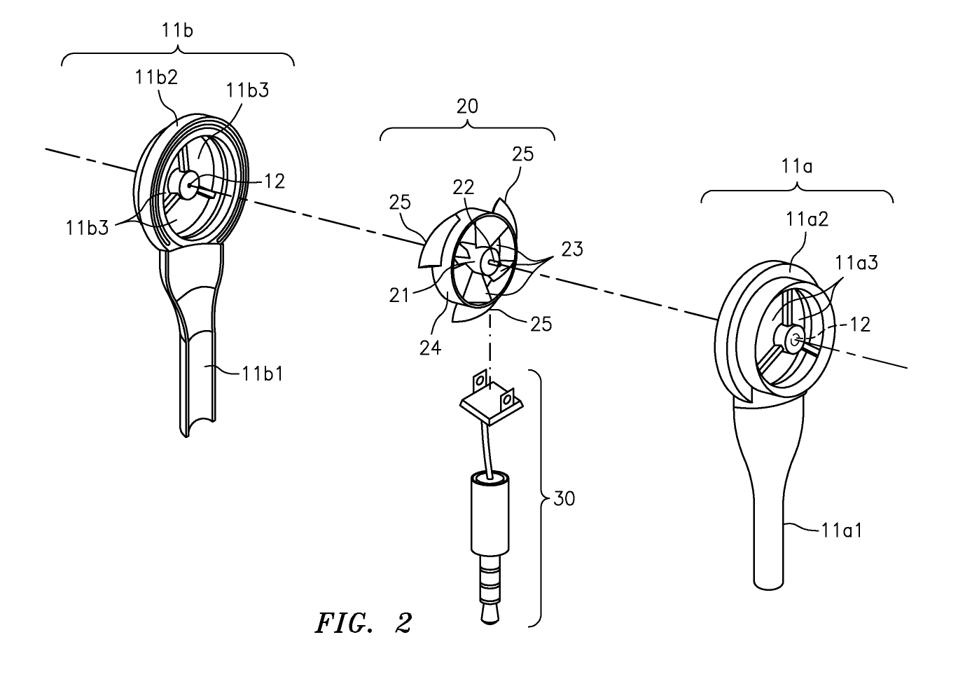

FIG. 2 is an exploded parts view of the device 10. As shown, the main body can be manufactured to include two complementary half sections 11a and 11b. Each of the main body sections having a lower portion 11a1 and 11b1, respectively forming a cavity for receiving the photo interrupter circuit 30, and a generally circular upper portion 11a2 and 11b2 for receiving the impeller 20. As shown, the upper portions can include any number of apertures 11a3 and 11b3, along with a pair of centrally located micro radial bearings 12 into which the axles of the impeller can be positioned. In this arrangement, the impeller can freely spin within the upper portions of the main body and can also be protected against direct impacts with foreign objects.

Although described above with respect to a particular shape and construction material, this is for illustrative purposes only, as the main body can take any number of different shapes and sizes, to suit any particular industry or use. Moreover, the main body can also be constructed from any number of different materials such as PVC and/or composites, for example utilizing known construction methodologies.

The impeller 20 can include a central hub 21 having an elongated axle 22 extending therethrough. A plurality of angled blades 23 radiate outward from the central hub and terminate into a continuous outer edge 24 having a plurality of fins 25 disposed thereon. As will be described below, the fins 25 will work in conjunction with the photo interrupter circuit 30 to generate airflow data. In the preferred embodiment, the impeller 20 can be constructed from injection molded plastic, and the axle 22 can be constructed from metal such as steel, for example. Of course, any number of other materials are also contemplated.

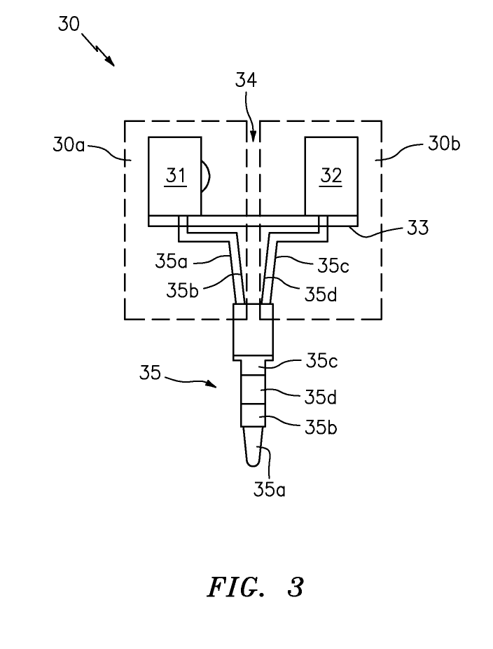

As shown best in FIG. 3, the photo interrupter circuit 30 can include an infrared LED 31 and a photoresistor 32 that are positioned onto a substrate 33 or other such member so as to leave a channel 34 through which the fins 25 of the impeller can pass. The LED and photoresistor are connected to an audio jack plug 35 having a first soundtrack terminal 35a, a second soundtrack terminal 35b, a microphone terminal 35c and a grounding terminal 35d.

In operation, the airflow balancing application 50 can generate a high frequency tone which can be played through the speaker output of the smartphone 5. As such, the first soundtrack terminal 35a can be 180 degrees out of phase with the second soundtrack terminal 35b, thereby generating a driver signal, which powers the left side of the circuit 30a. This power produces an alternating current through the infrared LED 31 which, in turn, generates light that is projected across the channel 34 towards the photoresistor 32.

The right side of the circuit 30b is powered by the microphone terminal 35c, and the current through it varies depending on the resistance of the photoresistor 32, which in turn varies according to the amount of infrared light hitting it. When the device 10 is placed near an HVAC duct, the air movement will spin the impeller 20, causing the fins 25 to pass between the LED 31 and the photoresistor 32, alternately blocking and unblocking the infrared light. This process causes the current within the right side of the circuit to vary, thereby creating a signal 40 that is transmitted to the smartphone via the microphone terminal 35c.

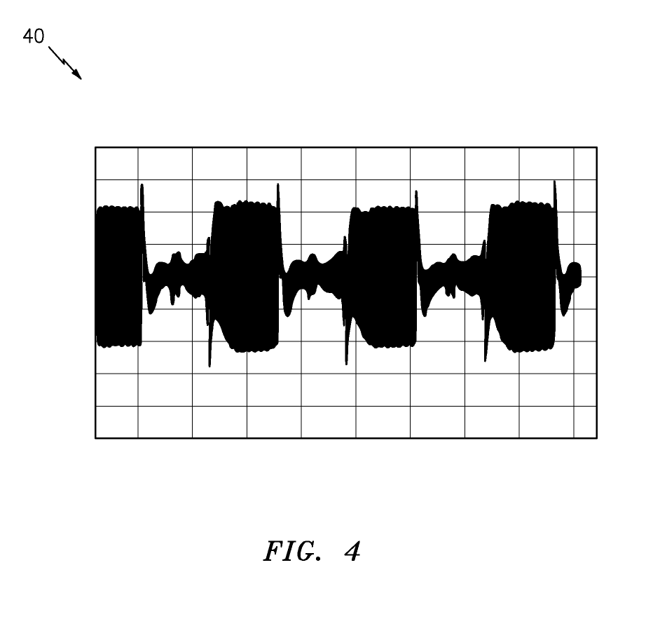

FIG. 4 illustrates one embodiment of the signal output 40 of the circuit 30. As shown, when the light is unblocked, the signal produced by the circuit 30 looks like a high frequency sine wave. When the light is blocked, the signal is a generally flat line. Upon receiving the signal, the airflow balancing app 50 can function to apply various digital signal processing algorithms to filter out the high frequency driver, and to extract the most significant frequency in the remaining signal. This most significant frequency is linearly proportional to air speed, and the exact relation between frequency and air speed is determined by a calibration process in a wind tunnel test facility. In this regard, the high frequency driver tone is designed to be significantly higher than the highest expected frequency of the spinning rotor.

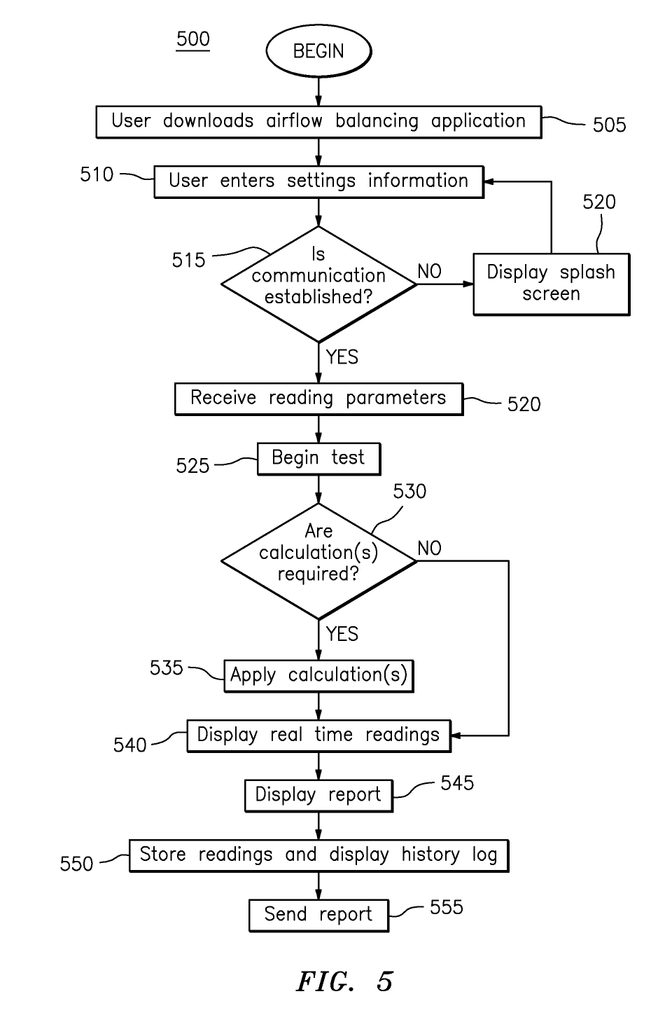

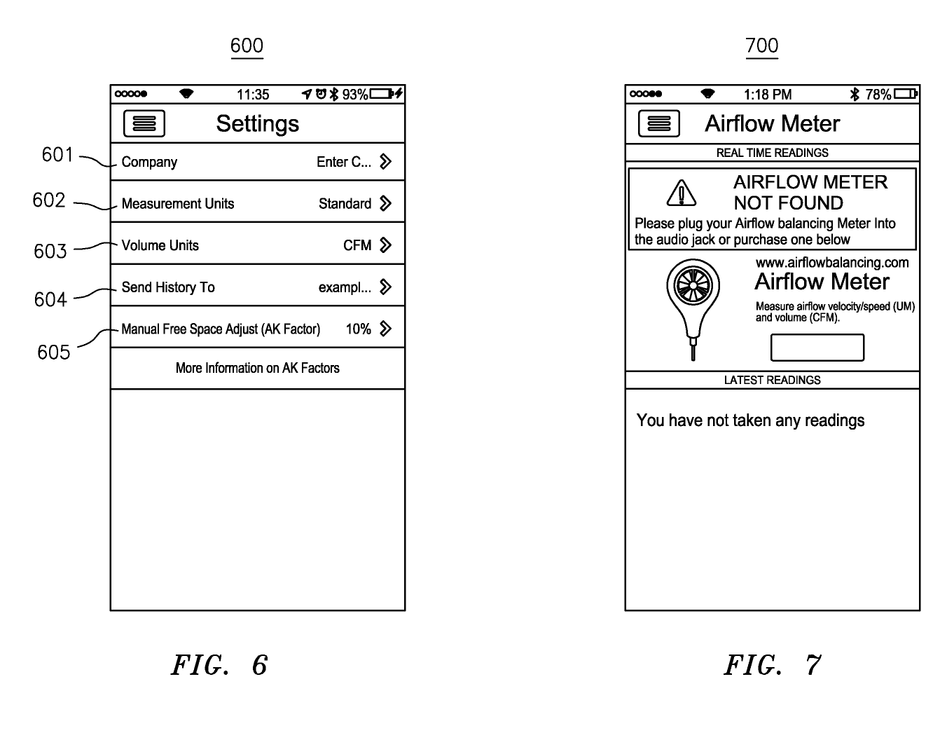

A method of using the smartphone-operated HVAC anemometer system 100 will now be described with respect to FIG. 5. Moreover, several exemplary presentation screens which can be generated by the system are presented with respect to FIGS. 6-10. Although described below with respect to particular steps and screens, this is for illustrative purposes only, as the methodology described herein can be performed in a different order than shown, and the presentation screens can include any number of additional information and features.

FIG. 5 illustrates an exemplary flow chart 500 of the airflow balancing application system that is useful for understanding the inventive concepts disclosed herein. As shown, the method can begin at step 505, wherein the consumer/user can download and install the airflow balancing application 50 onto their smartphone device.

After the initial install and when the App is launched for the first time, the method can proceed to step 510 wherein a Settings screen can be generated by the system. The settings screen can provide and request information that will allow the user to capture airflow information with the system. In one embodiment, the settings screen can provide preliminary information to the user, such as safety information, operating instructions, local ordinances, and the like, before allowing the user to establish communication between the smartphone 5 and the anemometer 10. Additionally, the settings screen can allow the user to input various preferences.

FIG. 6 illustrates an exemplary Settings presentation screen 600 which can be generated by the application 50 to be displayed to a user on the smartphone device 5. As shown, the settings screen 600 can include any number of user selectable options such as allowing the user to input their company name 601, units of measurement 602, volume units 603, an email address to which history reports can be sent 604, and AK factor adjustments 605.

In step 515, the system can identify whether the anemometer device 10 has been connected to the smartphone. If the App 50 is unable to detect the device, the system can generate a notification screen 700, such as that illustrated in FIG. 7, until the device has been connected. Once identifying that the device is connected to the smartphone, the method can proceed to step 520 wherein the user can be presented with options for selecting the parameters of the reading about to be taken.

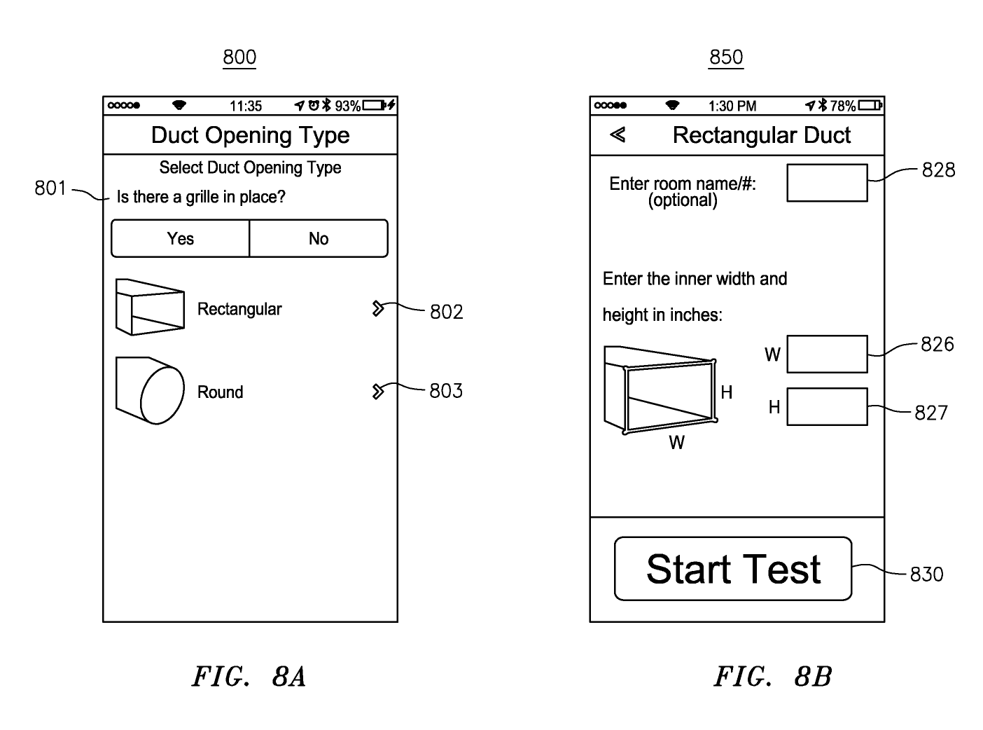

To this end, FIG. 8A illustrates an exemplary Duct Opening screen 800 generated by the application 50 to be displayed to a user on the smartphone device 5. As shown, the duct opening screen can include options for allowing a user to select whether the duct has a grille in place 801, and the shape of the duct opening such as rectangular 802, or round 803. Upon receiving this information, the system can generate a dimensions screen 850 (FIG. 8B) wherein the user can enter the width 826, height 827 or diameter (not illustrated) of the duct. Additionally, the user can assign a unique name or identifier 828 for this duct, which can be included in the below described report. Once all requested information has been received, the user can start the test at step 525 by selecting the Start Test button 830.

At step 530, the device 10 can be placed near the duct so as to detect the wind movement as described above. Prior to, or during the testing period, the system can determine 530 if calculations are necessary to render the airflow information, based on the parameters selected by the user in step 520. If calculations are needed, the system can apply one or more algorithms and/or mathematical steps to the airflow data being received from the device 10, in order to calculate 535 the requested airflow information. In this regard, the Airflow balancing App 50 that is loaded onto the smartphone 5 can include and store within the smartphone memory any number of different mathematical equations, algorithms and/or process steps that are necessary to determine the requested airflow information. As such, the smartphone processor can be utilized to apply one or more stored equations to the airflow data from the anemometer 10, and can display the same to the end user.

For example, if the parameters of step 525 indicate a rectangular grille, the system can apply the following formula:

W×H×LFM/144=CFM\

if grille=yes, then CFM×0.90=net CFM

Likewise, if the parameters of step 525 indicate a round grille, the system can apply the following formula:

(DIA/2)²×3.14159×LFM/144=CFM

if grille=yes, then CFM×0.90=net CFM

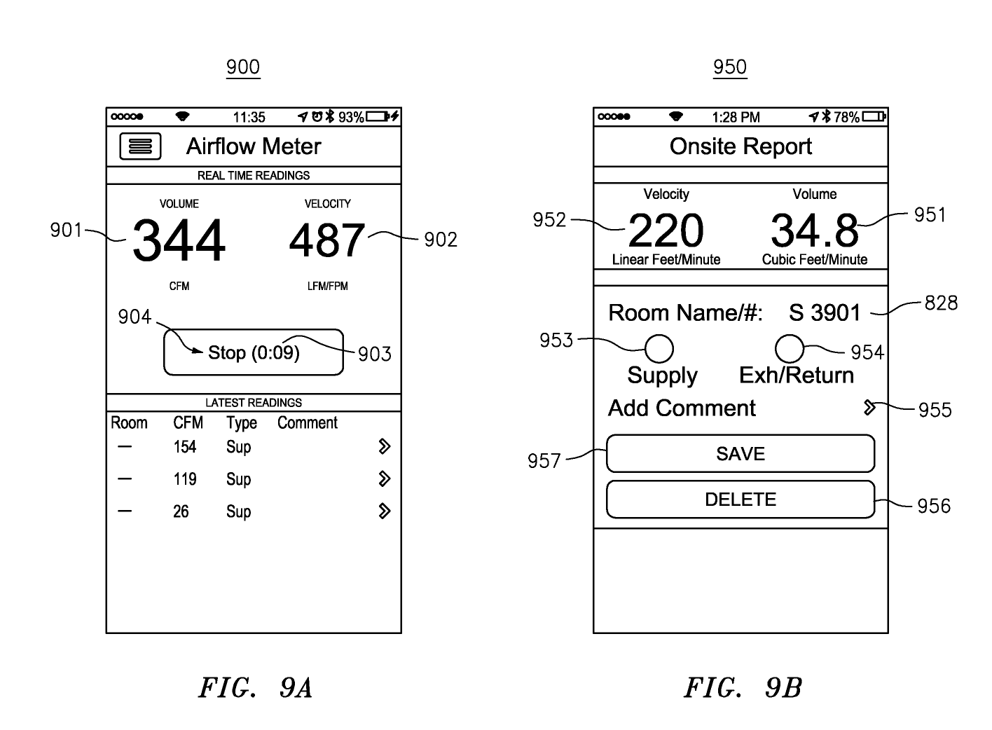

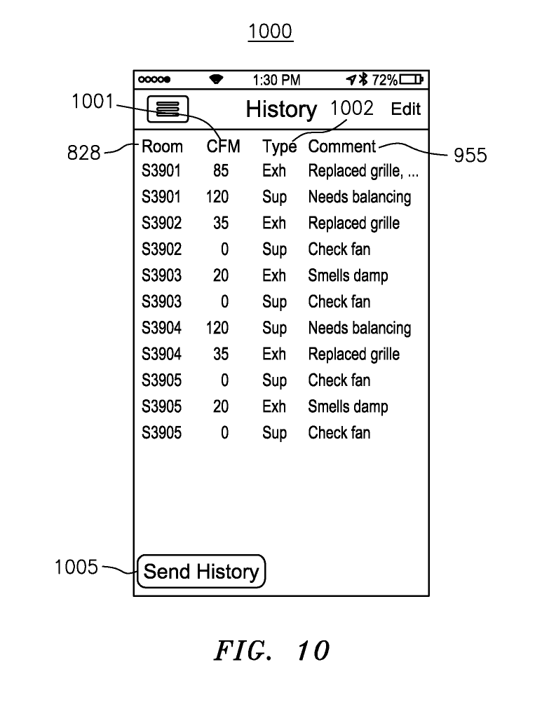

Of course, many other formulas and/or equations can also be applied such as values for compensating for the AK factor, and other such items based on the entered parameters and requested information. In either instance, during the test period, the system can display the real time readings to the user at step 540 via a presentation screen as shown in FIG. 9A. As shown, the readings screen 900 can include a digital presentation of the airflow as it is captured. This information can include, for example the airflow volume 901, and the airflow velocity 902. As shown, the readings will be in the units selected by the user in step 510. In the preferred embodiment, the reading will last for 30 seconds, in order to account for any brief fluctuations or anomalies in airflow, however other periods of time can be specified. As such, the screen 900 can provide a timer 903 which can display the test time. A stop command 904 is provided wherein the user can terminate the test at any time.

Once the readings have been taken, the method can proceed to step 545 wherein the system can generate an Onsite Report. As shown in FIG. 9B, the Onsite Report screen 950 can include the total average the airflow volume 951, and airflow velocity 952 for the location 828 identified at step 525. At this time, the user can specify whether the reading was taken from a supply 953 or return vent 954, and the user can enter any comments 955 which he or she would like included in the final report.

Once completed, the method can proceed to step 550, where the onsite report for the identified vent can be deleted 956 or saved to the history log 957. FIG. 10 illustrates one embodiment of the History log 1000 which can be generated by the system. As shown, the log can include each of the readings taken by the device 10 and the same can be sorted based on the unique identifier 828, the Airflow information 1001 (e.g., the airflow volume 901 and/or the airflow velocity 902), the reading type 1002 (e.g., a supply vent 953 or a return vent 954), and any user comments 955 for each particular reading. Of course, any number of other fields and/or information can also be displayed in the log.

Finally, the method can proceed to step 555 where the system can allow the user to generate and send a report containing individual readings and/or the History log by selecting the send history button 1005. In one embodiment, the report can automatically be transmitted as an HTML document to the contact address 604 listed at step 510. Of course, other embodiments are also contemplated wherein the user can select alternate and/or additional contacts, file types and/or transmission methods such as text messages, social media posts, encrypted/secure transmissions and the like, utilizing the smartphone components.

Although described and illustrated as displaying and calculating certain types of airflow information from the HVAC system of a building, those of skill in the art will recognize that the system 100 can be configured to display and calculate an unlimited amount of information from virtually any known air source, without undue experimentation, and without deviating from the scope and spirit of the inventive concepts disclosed herein.

Accordingly, the above described device and system provides users with a low cost alternative to stand alone anemometer devices, and utilizes the processing power and communicative ability of the users own smartphone calculate, store and transmit airflow information in a novel manner.

As described herein, one or more elements of the smartphone-operated HVAC anemometer device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package, partly on the user's smartphone and partly on a remote computer or entirely on the remote computer or server. In the latter scenario, the remote computer may be connected to the user's smartphone through any type of network, including a cellular network connection, a local area network (LAN) or a wide area network (WAN), or the connection may be made to an external computer (for example, through the Internet using an Internet Service Provider).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An airflow anemometer system, comprising:
an airflow balancing application that includes machine readable instructions for execution on a smartphone device having a processor, a memory, internet connectivity, a display screen and a headphone jack, said application functioning to
generate an airflow balancing icon on the display screen, and
calculate airflow information and display the same on the display screen; and
an anemometer device that includes
a main body having an external surface that defines an internal cavity,
an impeller that is positioned within the main body,
a photo interrupter circuit that is in communication with the impeller, and
an audio jack plug that is in communication with the photo interrupter circuit and functions to communicate with the headphone jack to transmit airflow data to the airflow balancing application.

2. The system of claim 1, wherein the photo interrupter circuit comprises:
a photoresistor;
an infrared LED that functions to direct infrared light onto the photoresistor;
a channel disposed between the infrared LED and photoresistor; and
a substrate onto which the infrared LED and photoresistor are positioned.

3. The system of claim 2, wherein the audio jack plug includes a first soundtrack terminal, a second soundtrack terminal, a microphone terminal and a grounding terminal.

4. The system of claim 3, wherein the infrared LED is in communication with the first and second soundtrack terminals, and the photoresistor is in communication with the microphone terminal.

5. The system of claim 4, wherein the an airflow balancing application is further encoded with instructions to generate a high frequency tone for output by the headphone jack of the smartphone device.

6. The system of claim 5, wherein the first and second soundtrack terminals include functionality for receiving the high frequency tone and providing the same to the infrared LED.

7. The system of claim 6, wherein the high frequency tone functions to provide operating power to the infrared LED.

8. The system of claim 4 wherein the photoresistor functions to generate an output signal that is transmitted by the microphone terminal to the airflow balancing App.

9. The system of claim 8, wherein the output signal is proportional to a speed at which the impeller rotates.

10. The system of claim 1, wherein the impeller includes a continuous outer edge having a plurality of outward radiating fins disposed thereon.

11. The system of claim 1, wherein the airflow balancing application further includes functionality for storing one or more algorithms within the memory of the smartphone device.

12. The system of claim 11, wherein the airflow balancing application further includes functionality for applying one or more of the stored algorithms to the airflow data to generate the airflow information.

13. The system of claim 12, wherein the airflow information includes at least one of an air velocity, and an air volume.

14. The system of claim 1, wherein the airflow balancing application further includes functionality for applying a different algorithm based on a shape of an HVAC duct.

15. The system of claim 1, wherein the airflow balancing application further includes functionality for creating a history log screen displaying the airflow information.

16. The system of claim 15, wherein the airflow balancing application further includes functionality for instructing the smartphone to transmit the history log to a secondary device.
